(19) United States
(12) Patent Application Publication
(10) Pub. No.: US 2015/0081476 A1
(43) Pub. Date: Mar. 19, 2015

(54) ANONYMIZING BUYER IDENTITY DURING COMPREHENSIVE PRODUCT EVALUATIONS AND VENDOR RESEARCH

(71) Applicant: GEOFF REGO, CUPERTINO, CA (US)

(72) Inventor: GEOFF REGO, CUPERTINO, CA (US)

(21) Appl. No.: 14/029,595

(22) Filed: Sep. 17, 2013

(51) Int. Cl. G06Q 30/06

(52) U.S. Cl. CPC G06Q 30/0615
USPC 705/26.42

(57) ABSTRACT

Some embodiments include a system for maintaining anonymity of a buyer during a process of performing vendor research for a buying project. The system includes a proxy environment to anonymously represent the buyer during the vendor research process. The proxy environment is configurable for the buyer to create an RFI associated with the buying project or for the vendor to invite a buyer to communicate with them anonymously. The system includes a vendor invitation manager that invites the vendors to participate in the buying project and interact with the buyer in a way that maintains buyer anonymity via the proxy environment. In some embodiments, the system includes a query manager that generates a set of queries that the buyer requests vendors to respond to. Vendors can respond to or ignore the set of queries.

### BACKGROUND

The embodiments herein relate generally to research into vendor pricing and product offerings, and more particularly to anonymizing identity of consumers engaged in online vendor research and evaluations of vendor products.

Many people, businesses, organizations, groups, and other entities (hereafter referred to as “buyers”) engage in projects that require product purchases, product leases, and/or services agreements from one or more vendors. Before purchasing, leasing, and/or entering into service agreements, buyers need to determine whether price, compatibility, quality, and other characteristics of vendor-offered products and/or services satisfy project requirements. In doing so, buyers typically research and evaluate one or more vendors, products, and/or services (hereafter referred to as “vendor research”). Many buyers perform vendor research online (i.e., on the Internet). In order to control the buying decision process without unwanted vendor pressure and persuasion, a buyer may need to perform vendor research without revealing identity (i.e., the buyer needs to remain completely anonymous to the vendor while researching and making a buying decision). However, initiating and performing such research often necessarily results in exposure of the buyer's identity.

In order to overcome this problem, buyers currently try to remain anonymous by using fake or seemingly arbitrary identifying information. For example, a buyer may input a fake email address, a public domain email address, or other fake information, in a vendor form that requires an email address and/or other information, or the buyer may set a parameter of a web browser to operate in “anonymous” mode, so as to research particular vendors without leaving identifying information. These efforts to bypass identification are ineffective in maintaining anonymity while engaging in comprehensive evaluations and research, because vendors often have other means to establish identity. For example, vendors can enforce policies on the distribution of information, such as (i) making information available only to buyers with email addresses of verifiable business, not generally-available email addresses (e.g., no information for Yahoo!, Google, and other such email addresses), (ii) preventing information distribution to web browsers operating in “anonymous” mode, and (iii) making proactive efforts to establish identity in spite of the buyer's resistance to revealing identify, such efforts including performing reverse IP look ups, tracking web activity via one or more cookies, and reviewing social media profiles and activities to automatically detect a buyer's identity.

Thus, what is needed is a way for buyers to remain anonymous while communicating with vendors during vendor research and evaluations.

### BRIEF SUMMARY

Some embodiments of the invention provide a novel system for maintaining anonymity of a buyer during a process of performing vendor research and evaluation. In some embodiments, the system includes proxy environment to anonymously represent the buyer during the vendor research and evaluation process. In some embodiments, the proxy environment is configurable for the buyer to create a purchase specification related to a particular buying project. In some embodiments, the system includes a vendor invitation manager that invites vendors to collaborate with buyers on a buying project in the proxy environment. In some embodiments, the system includes a query manager that generates a set of queries that the buyer includes in the purchase specification. In some embodiments, the query manager transmits the set of queries to one or more vendors associated with the purchase specification, receives vendor responses to the set of queries, and posts the vendor responses to the purchase specification in the proxy environment.

In some embodiments, the system is implemented as a set of processes that operate on a set of computing devices communicably connected via a network. In some embodiments, a client process for anonymizing buyer identity during vendor research is performed by a software application operating on a computing device. In some embodiments, a server software application performs a process that establishes a proxy environment based on one or more purchase specifications of a particular buyer, and facilitates anonymous research of one or more vendors associated with the purchase specification.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic of a system that facilitates anonymous buyer research of vendor-based information related to a particular purchase project in some embodiments.

FIG. 2 conceptually illustrates a process for generating queries for vendor response by a buyer for a particular buying project in some embodiments.

FIG. 3 is a continuation of the process described by reference to FIG. 2.

FIG. 4 conceptually illustrates a process for participating in a buying project and responding to queries for information in some embodiments.

FIG. 5 is a continuation of the process described by reference to FIG. 4.

FIG. 6 conceptually illustrates an example of a graphical user interface (GUI) for interacting with the anonymous buyer purchase project system in some embodiments.

FIG. 7 conceptually illustrates an electronic system with which some embodiments of the invention are implemented.

### DETAILED DESCRIPTION

In the following detailed description, several examples and embodiments of the invention are described. However, it will be clear to a person skilled in the art that the invention is not limited to the embodiments set forth and can be adapted for any of several other uses.

Some embodiments of the invention provide a novel system for maintaining anonymity of a buyer during a process of performing vendor research. In some embodiments, the system includes proxy environment to anonymously represent the buyer during the vendor research process. In some embodiments, the proxy environment is configurable for the buyer to create a purchase specification related to a particular buying project. In some embodiments, the system includes a vendor invitation manager that invites the vendors to associate with the purchase specification in the proxy environment. In some embodiments, the system includes a query manager that generates a set of queries that the buyer includes in the purchase specification. In some embodiments, the query manager transmits the set of queries to one or more vendors associated with the purchase specification, receives vendor responses to the set of queries, and posts the vendor responses to the purchase specification in the proxy environment. Queries can also be generated by vendors for responses from buyers via the proxy environment.

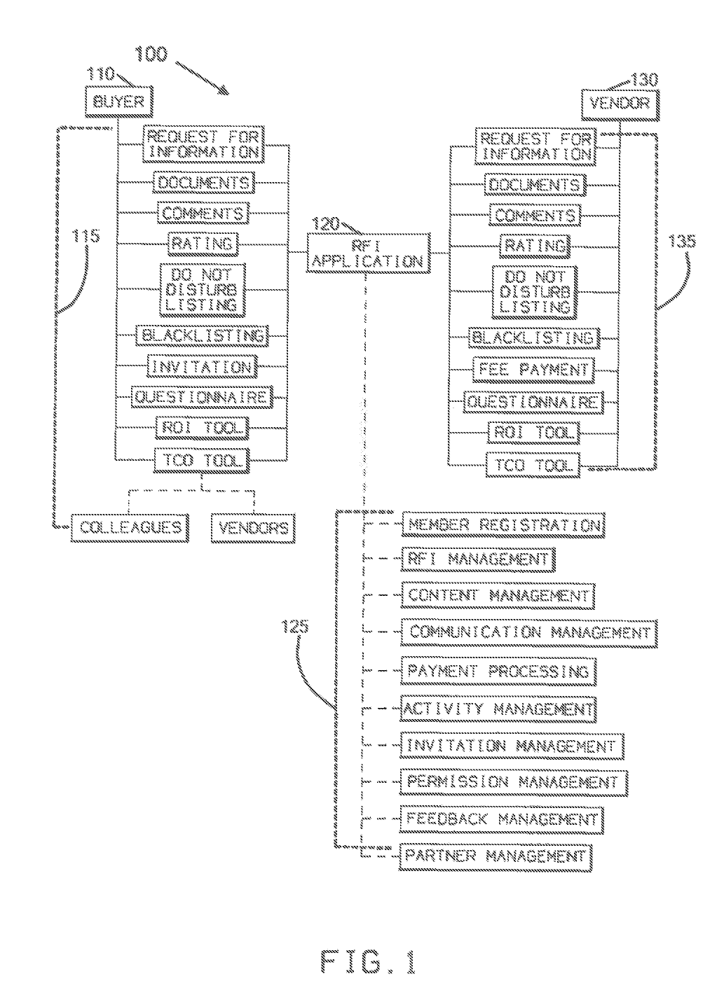

FIG. 1 conceptually illustrates a schematic of a system that facilitates anonymous buyer research of vendor-based information related to a particular purchase project in some embodiments. In some embodiments, the system is implemented as a set of software applications operating on a set of computing devices communicably connected over a network. As shown in this figure, the system 100 comprises a buyer application 110, a set of buyer tools 115, an RFI application 120, a set of processing modules for managing operations performed by other applications connected to the RFI application over the network 125, a vendor application 130, and a set of vendor tools 135. In some embodiments, the set of buyer tools correspond to the set of processing modules 125 of the RFI server application 120. Also, the set of vendor tools 135 in some embodiments corresponds to the set of processing modules 125 of the RFI server application 120.

The system 100 of some embodiments facilitates buyer and vendor interaction while ensuring that the buyer remains anonymous during one or more product/service evaluations and while performing vendor research. Thus, instead of the buyer 110 interacting directly with the vendor 130 via conventional methods, such as email, phone, website visits, social media properties, etc., the system 100 provides a proxy environment in which buyers create queries (messages, questionnaires, RFIs, RFPs, RFQs, documents, etc.) and indicate a list of vendors they would like to invite to respond to the queries. The proxy environment is therefore a virtual engagement space that maintains anonymity of buyers. The proxy environment can be initially accessed and set up by the buyer prior to performing vendor research.

In some embodiments, a non-buyer entity may provide a feature that allows a buyer to initialize and set up a proxy environment. The non-buyer entity in some embodiments is one of a vendor and an affiliate. The feature can be a tool in a graphical user interface of a website, a tool in a mobile application, a selectable item embedded in an email message, a software application tool, etc. The tool or item for allowing the buyer to initialize and set up the proxy environment can be a widget, a plug-in, a clickable button, a clickable text or image item, a selectable entry from a list, a selectable icon, a selectable menu item, etc. The feature works to give buyers an option of remaining anonymous even after the buyer has accessed a digital property (e.g., a website, a mobile app, etc.) associated with a vendor or affiliate. For example, the vendor may provide a mobile application with a tool for the buyer to click in order to start the process of setting up a proxy environment. Likewise, an affiliate of an entity that deploys an RFI server application 120 may have a website with a GUI tool, such as a selectable widget or icon, which allows the buyer to easily start the process of setting up a proxy environment.

In some embodiments, the proxy environment is deployed in the RFI application 120 operating on a server. The RFI application 120 of some embodiments requires that a buyer first register with the system 100. The buyer can start registration by accessing the RFI application directly (e.g., accessing a website for registration) or indirectly (e.g., by selecting a proxy environment setup widget on a vendor website). Regardless of manner in which the buyer starts the process, once registration is started, the RFI application performs member registration operations that allow the buyer to create a profile for vendors to see without revealing the buyer's identity. In some embodiments, buyers register using one or more verifiable communication channels. For example, the RFI application may require that the buyer provide an email address associated with a business that can be verified in some manner (e.g., via interfaces to databases from governmental entities, such as the Secretary of State of a particular state, or databases from commercial organizations who aggregate business information, such as Dun & Bradstreet (D&B) and other such private entities who provide business information).

Once a valid email address is verified, a buyer profile is generated by the RFI application. In some embodiments, the buyer profile is initially generated with only the verified email address of the buyer. In some embodiments, after the buyer profile is registered, the buyer can add additional information to the profile. Although the buyer provides a verifiable email address in order to register in some embodiments, the buyer's email address (and any other identifying information) is not disclosed to any vendors. For instance, in addition to a valid and verifiable organization email address (e.g., john.doe@doe-industries.com), the buyer may provide other personal identification information such as name (i.e., John Doe), company name (i.e., Doe Industries, Inc.), secondary email addresses (i.e., john_doe@generic_email.com), etc. In some embodiments, such personal identifying information is automatically set to a private status by the RFI application. In some embodiments, the buyer can override the automatically set status from private to public, or from private to selectively public, or from private to some other status that allows the buyer to control the release of certain identifying information.

In some embodiments, the buyer profile includes a set of public information which is not hidden from vendors. The public profile information of some embodiments comprises one or more of the buyer's job title, a generic description of the buyer's organization, the buyer's general location (e.g., California), the buyer's more specific location (e.g., Santa Clara, Calif.), financial information (e.g., revenue of a for-profit company, budget of a non-profit organization, etc.), the organization's field or industry, etc. In some embodiments, the public profile information is set by the RFI application to a public status which allows complete vendor viewing. In some embodiments, the RFI application authenticates at least some of the public information provided by the buyer in order to ensure informational integrity. Thus, some or all of such generic buyer information may be verified against commercial databases, such as Dun & Bradstreet (D&B) to ensure that the buyer is setting up an accurate profile for vendor viewing.

After a buyer has registered, the RFI application 120 can accept communications from the buyer 110 and the set of designated vendors (i.e., vendors who are included in the “invite” list to participate in the buyer purchase). For example, when buyers create a buying project, they can indicate a list of vendors they would like to invite to their buying project. The system 100 will then generate the virtual proxy environment in which the buyer remains anonymous to the vendors. The buyer remains anonymous because the RFI application sends the invitation emails to the list of invited vendors. Vendors who choose to accept invitation and respond to buyers queries associated with buyers buying project have to do so via this proxy application where vendor has no technical ability to know who the buyer is. Thus, the proxy software operating on the RFI server 120 provides all of the ability for a buyer to perform vendor research, while ensuring buyer anonymity. This gives the buyer complete control over various aspects of the buying process. When buyers create a buying project and indicate a list of vendors they would like to invite to their buying project, the system 100 generates the virtual proxy environment in which the buyer remains anonymous to the vendors.

After the proxy environment is set up and associated with the buying project, the buyer can use any of several tools 115 to interact with vendors. The set of tools used by the buyer ensure that the buyer remains anonymous even when interacting with one or more vendors. In some embodiments, the tools 115 comprise an RFI tool for requesting information, a content management tool for managing documents and files uploaded into the system, a communication management tool for managing inter- and intra-party communication within the proxy environment, a payment management tool, an activity management tool, an invitation manager, a permission management tool, a feedback management system, and a partner management system.

In the proxy environment the buyer can generate requests for information that the buyer is interested in learning about. Requests for information are one type of query that buyers can issue for vendor response and feedback. The types of queries that a buyer can use in a buying project are numerous, and often can be customized for particular aspects of the buying project. Examples of some standard queries that a buyer application 110 can issue to the RFI application server 120 for vendor 130 response include (i) requests for information (RFI), (ii) requests for product (RFP), (iii) requests for qualifications (RFQ), (iv) questionnaires (customized by anonymous buyer's design), (v) messages (informational statements and prompts that invite response by vendors), (vi) documents (for vendors to review and respond to), (vii) return on investment information (ROI, quantified by standard calculations or any other computation that provides an indication of an economic return on an initial expenditure), (viii) total cost of ownership information (TCO), etc. While this list of queries that a buyer can issue to one or more vendors for response is limited, a person of skill in the art would appreciate that many other types of informational queries can be included.

In some embodiments, the buyer is able to issue requests for information using the RFI tool. For example, the buyer may wish to learn about service and support features that may or may not be associated with one or more products that could be purchased. Using the request for information (RFI) tool, a buyer creates a query intended for one or more vendors. The RFI tool of some embodiments permits the buyer to specify at least a name for the query, a description of the information requested in the query, and an enumeration of any documents that may be associated with the information request. For example, a buyer may use the RFI tool to generate a query requesting TCO information for a particular product. The buyer would be able to request any documentation supporting the TCO that a vendor might provide, and may even describe one or more constraints related to the TCO analysis (e.g., total cost of ownership based on California State tax requirements, or total cost of ownership using generally accepted accounting principles, etc.). Thus, by using the RFI tool, the buyer can obtain information needed to make an informed buying decision, without revealing identity.

After the buyer selects one or more of the queries at the buyer application 110, the queries are transmitted over the network to the RFI application operating on the server computing device 120 that hosts the proxy environment. In some embodiments, the RFI application posts the queries in the proxy environment for vendors to view and respond to. In other embodiments, the RFI application sends (e.g., via email, instant message, or other means for communicating) the queries to the vendors for vendor processing. In these embodiments, the vendor uses one or more of the vendor tools 135 on the vendor application 130 to respond to the queries. As shown, the vendor can respond with information (e.g., written text information), documents, comments, ratings, responses to each query in a questionnaire, provide a calculation for ROI, and a value for TCO, among other forms of legitimate responses. The system 100 only constrains the vendor application 130 in ways that ensure a vendor provides responses to particular types of queries in the form requested. For instance, the vendor can use the ROI tool to provide an objective calculation for an expected return on investment in response to buyer's ROI query, but the vendor cannot simply input any value at will.

While a buyer can request documentation that supports a vendor's response to a query that is generated with the RFI tool, the buyer can also provide documents for vendors to view in relation to one or more buying or informational needs. In some embodiments, the content management tool is for managing documents and files in the proxy environment. For example, the buyer may wish to share a requirements list with all invited vendors and can upload the document into the content management system. The documents and files that are uploaded into the content management system are controlled based on a set of user permissions. For instance, when a vendor uploads a document for the buyer to review, only the buyer and submitting vendor will have the permissions necessary to see and access the document. The range of permissions each vendor has can be set in some embodiments by the buyer, and the permissions can be varied across different documents and files uploaded to the content management system. For example, the buyer might set all vendors to have at least read access to a particular document, but may only permit read access to a specific vendor for another document. When a vendor has write access to a document, the vendor is permitted to update the contents of the document and save it in the content management system. Typically, permissions to remove or delete files is granted on a limited basis to vendors. Yet, in some embodiments, vendors can also use the content management system as a space for storing and/or sharing documents that may have not be solicited by the buyer. In these embodiments, the vendors have full permissions over the files and documents in their private content space, but once the documents are submitted into the proxy environment for the buyer to view, any permissions the vendor had over the document are superseded by permissions set by the buyer.

In some embodiments, the communication manager is a subsystem that is responsible for communication between members in the system. For example, the communication manager facilitates communication between vendors and individual buying members (e.g., the buyer and any other invited associates) via email, chat, phone, fax, tweets, and any of several other manners of digital communication. In some embodiments, the communication manager can set some communications to be uni-directionally anonymous while setting other communications to be bi-directionally anonymous. A buyer would want to contact a vendor by posting a comment in the application and have that comment delivered to the vendor via an email without having the buyer's email disclosed. In other instances a buyer may wish to communicate anonymously with a vendor via email directly without using the application. In this case the system generates an anonymous email for the buyer and/or seller. All communication go via these anonymous email addresses and the proxy servers translate and forward the emails to the intended recipients.

The payment processing tool enables fee collection from buyers and/or vendors in some embodiments. For example, the payment tool can be enabled to require payment of a transaction fee for a buyer to post an RFI or query or for a buyer to invite vendors to participate in an RFI. Likewise, the payment system can require payment from vendors to participate in an RFI or to perform other operations (e.g., uploading documents that exceed a size limit, transmitting more emails than permitted, etc.). In some embodiments, the payment processing system can accept payment in a standard non-cash form, such as by credit card, debit card, etc.

The activity management tool tracks operations performed by each party in the proxy environment in some embodiments of the system. For example, the activity manager may track emails that are sent from the buyer to the vendors and may send the buyer of notification when the email is opened for each particular vendor. As noted above, however, all of the operations and transactions that one party performs are anonymous with respect to the other party. Nevertheless activity information is important to both buyer and vendor because in the anonymous proxy environment, a vendor would at least like to know whether certain activities are being performed by the buyer, and likewise, the buyer would like to know where things stand with vendors. For example, a buyer may want to know whether or not a vendor viewed the buyer's invitation, since a non-response could then prompt the buyer to categorize the vendor as not interested in being included in the buying project. The vendor would also like to know if the buyer viewed one or more responses the vendor posted to an RFI of the buyer. The activity manager provides this functionality by tracking and recording every time a comment is made to an RFI, every time a document is uploaded to an RFI, every time a member is invited to participate in the RFI, and every time some other operation or transaction is performed. In this way, the activity manager provides both buyers and sellers visibility into the status of any individual invitation or RFI query.

While the activity manager provides some information about the status of activities related to invitations, a more specific tool is provided in the invitation management tool. A buyer can use the invitation manager perform several invite-related operations, including at least (i) inviting colleagues and vendors to participate in an RFI, (ii) specifying the types of permissions that invited vendors have while participating in the RFI, and (iii) specifying a list of emails and/or vendor website addresses to invite to participate in the RFI. In some embodiments, the invitation manager performs a quality check on the addressing information used to invite a vendor. For example, the invitation manager may review the domain name in the vendor's email address in order to determine whether the vendor is associated with a known identity for the vendor (i.e., by comparison to a website known to be the vendor's website). Thus, the invitation manager ensures that only emails associated with the vendor's website can register to participate in the RFI.

In some embodiments, the permission management tool augments the automatically private profile information which can be selectively set by the buyer to be revealed to one or more vendors. As noted briefly above, the permission manager provides a number of additional ways to manage permissions, with both buyers and vendors being able, for example, to put each other into black lists and do-not-disturb lists. Different business processes can result out of these actions. For example when a vendor is listed in a do-not-disturb list of a buyer the vendor cannot communicate with the buyer. Attempts by the vendor to communicate with the buyer are blocked. The permission management tool also controls roles and permissions of each member in the system. For example, a member with the role of administrator may have the ability to add and delete documents associated with the RFI, whereas a member with just view role may only be able to view documents.

In some embodiments, additional tools are provided including a feedback manager that makes it possible for buyers and vendors to rate each other. In addition, a partner management tool provides features for affiliates or partners of an entity that hosts a proxy environment to interact with the entity. For example, an affiliate may drive business to the entity hosting the proxy environment and the entity may consequently share revenue with the affiliate. In some instances, the proxy hosting entity (i.e., the entity which deploys an RFI server to host a proxy environment) may provide a graphical user interface tool for affiliates to install on its website, in order to allow buyers on the affiliate website to interact anonymously with a vendor by selecting the tool to set up a proxy environment. In some embodiments, the proxy hosting entity provides code to implement a widget on a website of the affiliate in order to allow a buyer to interact anonymously with a vendor.

In some embodiments, buyers can initiate multiple buying projects that are each associated with a separate proxy environment on the RFI application server. Thus, when a buyer creates a first set of queries (messages, questionnaires, RFIs, RFPs, RFQs, documents, etc.) in a first proxy environment associated with a first buying project, the vendors associated with the first proxy environment receive the first set of queries, but vendors associated with a second proxy environment, corresponding to a second buying project of the buyer, will not receive the first set of queries. Instead, the vendors associated with the second proxy environment may receive queries that the buyer creates in relation to the second proxy environment. In this way, the buyer's identity is blocked across different proxy environments associated with different buying projects. Thus, even a vendor who is invited to participate in a single buyer's first and second proxy environments has no technical ability to know who the buyer is or that the buyer from the first proxy environment is the same as the buyer from the second proxy environment.

Several more detailed embodiments are described in the sections below. Section I describes a process for a buyer to create an RFI and interact anonymously with one or more vendors in relation to a buying project. Section II describes a process for a vendor to participate in a buying project created by an anonymous buyer. Next, Section III describes an electronic system that implements some of the embodiments of the invention.

I. Anonymous Buyer Query Process

In some embodiments, the system is implemented as a set of processes that operate on a set of computing devices communicably connected via a network. In some embodiments, a client process for anonymizing buyer identity during vendor research is performed by a software application operating on a computing device.

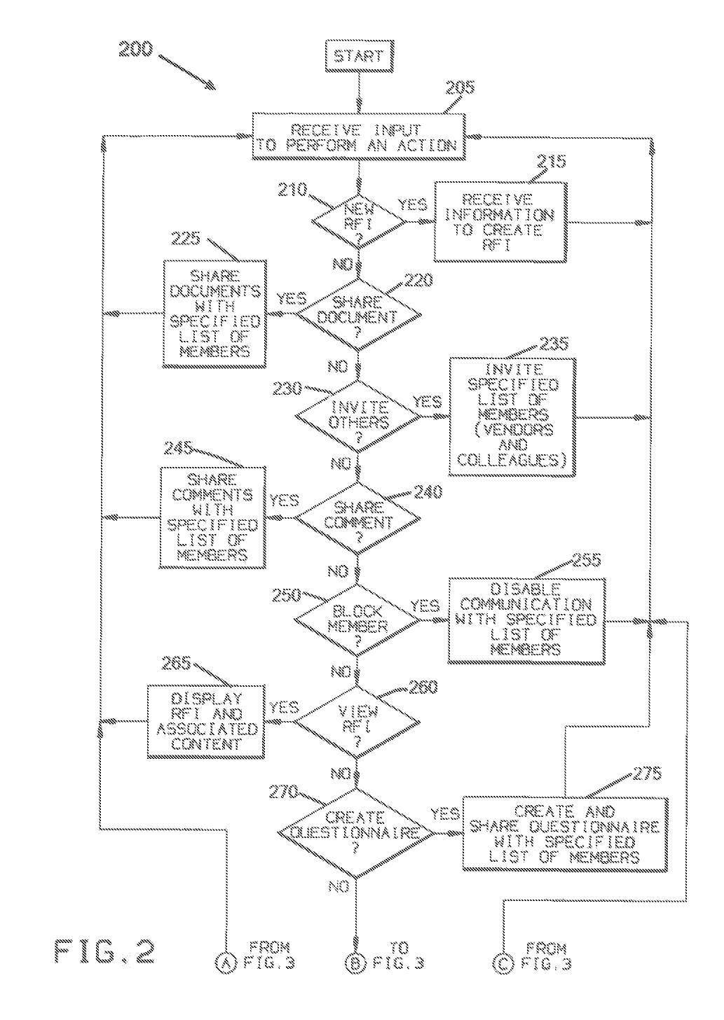

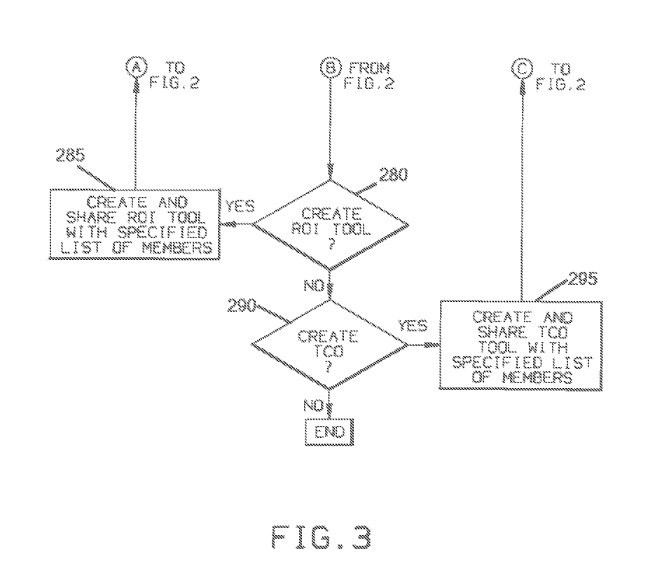

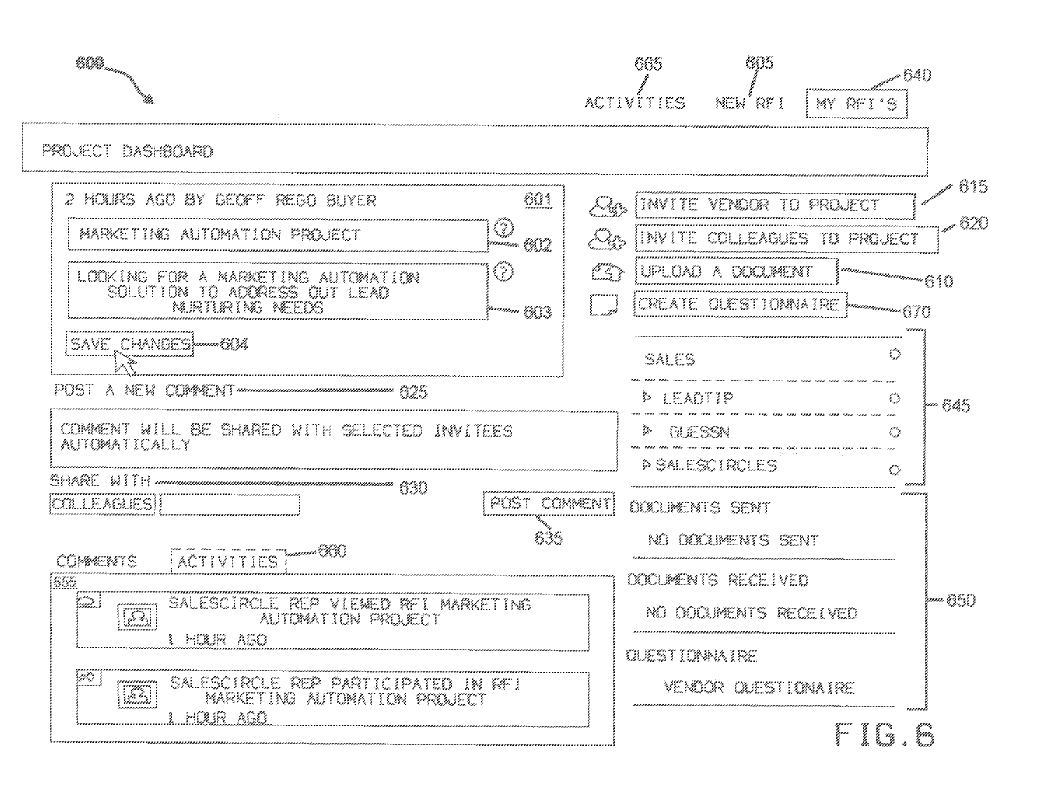

FIGS. 2 and 3 conceptually illustrate a process in some embodiments for generating buyer-initiated queries for vendor response. In some embodiments, the process 200 is implemented as a buyer proxy software program (such as the RFI application server 120) that runs on a computing device. In some embodiments, the buyer proxy program comprises a graphical user interface (GUI) for interacting within a virtual proxy environment that shields buyer identity from a set of invited vendors participating in a buyer's purchase project. The computing device can be a desktop computer, a laptop computer, and any of several mobile computing devices, including a tablet computing device, a mobile phone, and a mobile application device. The process 200 is described by reference to FIG. 6, which conceptually illustrates an example of a GUI 600 for a interacting with a buying project. As shown in the example GUI 600 in FIG. 6, an RFI 601 has already been created for a buyer's project. The RFI 601 displays some information about the buying project, specifically, an RFI title 602 (i.e., “MARKETING AUTOMATION PROJECT”) and a summary description 603 (i.e., “LOOKING FOR A MARKETING AUTOMATION SOLUTION TO ADDRESS OUR LEAD NURTURING NEEDS”) of the RFI 601. The buyer is able to change and/or update these RFI informational fields at any time by selecting the save button 604.

Referring back to FIG. 2, the process 200 starts after a proxy environment associated with a buyer's purchase project has already been created and the buyer's project and corresponding RFI 601 have already been set up. Although this example is described by reference to FIG. 6 which includes an RFI 601 that is already created, in some embodiments the process 200 starts before any RFI is created.

With or without an existing RFI, the process 200 receives (at 205) input to perform an action. A buyer can create any of several different actions in a proxy environment. When the process 200 receives the new action input, the process must determine which action has been requested. Although the process 200 in this example illustrates a particular order of determining which action was created, the order of determining which action was created can be different. Thus, the process determines (at 210) whether the buyer has created a new RFI. Referring to FIG. 6, if the buyer selects the “NEW RFI” option 605 in the graphical user interface 600, the buyer will be able to provide details pertaining to the new RFI. Referring back to FIG. 2, the process 200 would then receive (at 215) the information buyer inputs to create the new RFI. After the new RFI is created, the buyer can perform further actions as desired. Thus, the process 200 transitions back to 205 (which is described above) to receive any additional action inputs.

On the other hand, if the process determines that the new action was not an action to create a new RFI, then the process determines (at 220) whether the action is for sharing a document. If the buyer has selected the “UPLOAD A DOCUMENT” button 610 in the GUI 600 of FIG. 6, then the GUI will display a feature that allows the buyer to select a document to associate with a particular RFI and upload the document into the proxy environment. The buyer can also select one or more vendors to share the document with. The GUI of some embodiments displays a pop up window to select and upload a document and configure the document share settings. In other embodiments, the document can be selected by one or more of a drop down menu, a list selection, etc. Whatever the manner of selecting the document to upload, the buyer has the option to change or update the share settings at any time. Thus, the buyer is in complete control of the document. Referring back to FIG. 2, when the document is uploaded the process 200 shares (at 225) the document with the specified members. Then the process 200 transitions back to 205 to receive any further action inputs.

However, if the process determines that the buyer has not shared a document, the process next determines (at 230) whether the action input was to invite others to participate in the buying project and engage with the buyer anonymously in the proxy environment. Referring to FIG. 6, a selection of either the “INVITE VENDOR TO PROJECT” button 615 or the “INVITE COLLEAGUES TO PROJECT” button 620 would allow the buyer to specify one or more other parties participate in the RFI. The GUI 600 again would prompt the buyer with a window or display area to include contact information that would allow the invitees to be contacted. In some embodiments, the system requires a valid website address or valid email addresses to be input for each invitee in the list. The email addresses and websites, as noted above, can be validated in any of several ways, including checking the domain name associated with the email address to see if the email address is valid. The list of invitees can include both vendors and colleagues. Referring back to FIG. 2, when the buyer has completed entering the information for each invitee, the process invites (at 235) the specified list of members (i.e., both vendors and colleagues). Then the process 200 transitions back to 205 to receive any further action inputs.

To participate in the RFI, vendors would be able to view the invitation and decide whether or not to participate. In some embodiments, the vendors must affirmatively select an option to participate in the RFI. In some embodiments, each vendor who decides to participate pays a participation fee. In other embodiments, no participation fee is required but the vendor must reply to the invitation indicating that they will participate in the RFI. After the vendor affirmatively selects to participate, they will have a set of access rights in the proxy environment allowing them to engage with the buyer anonymously with respect to the RFI.

Next, the process 200 determines (at 240) whether the action input was to share a comment. If the buyer's action was to share a comment, the process shares (at 245) the comments with a specified list of members. If the action is not for sharing a comment, the process transitions to 250, which is described below. Referring to FIG. 6, a buyer using the GUI 600 can share comments by typing a text comment in the “POST A NEW COMMENT” input area 625 and share the comment with a selection of colleagues and/or vendors by indicating each member in the “SHARE WITH” boxes 630. In some embodiments, the buyer can select from a drop down menu who to share the comments with. For example, the buyer may select to share the comment with a single vendor (a private comment) and all colleagues, or alternatively, with all vendors (a global comment) and one or more colleagues. After the buyer has input the members with whom to share the comment, the buyer can select the “POST COMMENT” button 635 to share the comment. Referring back to FIG. 2, after the buyer shares the comment, the process 200 transitions back to 205, which is described above.

The process 200 next determines (at 250) whether the action received at 205 was to block one or more members. In some embodiments, the buyer or the vendor can put the other into do-not-disturb status in order to block communication with them. Since all communication is via the website/application that implements the proxy environment, any vendor who blocks the buyer is still prevented from knowing the identity of the buyer, while the buyer will know the identity of any vendor the buyer puts onto the do-not-disturb list. Thus, if the buyer's action at 205 was to block one or more vendors, the process disables (at 255) communication with the set of vendors specified in the do not disturb list. In some cases, the buyer can select a single vendor to block, and the vendor can be added to an existing do-not-disturb list (i.e., with other vendors) or a new do-not-disturb list can be generated if the vendor is the first to be blocked. Likewise, if the buyer selects multiple vendors to block, the process can generate a new list if no list presently exists for the RFI, or just add the vendors to a previously created list for the RFI, if one exists.

The process 200 next determines (at 260) whether the buyer has chosen to view an RFI. In the proxy environment, the buyer might have one or more ongoing RFI's that are active (i.e., expecting responses from vendors and still during the evaluation stage of the buying project). The buyer can select and view any of the active RFI's to display the content associated with the RFI. In some embodiments, the buyer can select and view expired, non-active RFI's that were previously created by the buyer for other buying projects. When the buyer selects an RFI to view, the process displays (at 265) the RFI and the associated content. For example, the buyer will have access to documents and comments associated with the RFI when the RFI has been selected for viewing. Referring to FIG. 6, the buyer can select an RFI by clicking the “MY RFI'S” button 640. In some embodiments, the GUI 600 displays a window with a list of the RFI's that are associated with the buyer upon selection of the “MY RFI'S” button 640. In some embodiments, the buyer can be associated with an RFI as a creating buyer member or as an associated colleague member. In some embodiments, if a buyer is associated with an RFI as a vendor, the RFI's by vendor association will be displayed along with the RFI's in which the buyer is the creating member or a colleague of a creating member. As shown in FIG. 6, the buyer is able to view RFI name 602 and summary 603, as well as comments 655 that have been shared and activities (i.e., by selecting the “ACTIVITIES” tab 660) that have been completed. In addition, the buyer can view RFI relationship management details 645 and summarized document and questionnaire information 650. In some embodiments, the activities under the “ACTIVITIES” tab 660 are listed in realtime as activities occur. In some embodiments, only the most recent activities are displayed under the “ACTIVITIES” tab 660. A comprehensive list of activities associated with the RFI can be viewed by the buyer, however, by selecting the top-level menu “ACTIVITIES” tab 665. In this way, the buyer is able to keep an eye open for on-going activities, and refer back to all activities if necessary.

Referring back to FIG. 2, the process transitions back to 205 after viewing is complete (i.e., when a new action is performed). On the other hand, if the action performed at 205 was not for viewing an RFI (as determined at 260), the process then determines (at 270) whether the action was for creating a questionnaire. If the buyer's new action is for creating a questionnaire, the process 200 will create and share (at 275) the questionnaire with a specified list of members, after which, the process will proceed to 205, as described above. In some embodiments, the buyer selects the members to which the questionnaire should be directed. In these embodiments, the buy can select individual member piecemeal or can select all vendors. Referring to FIG. 6, the GUI 600 allows the buyer to select the “CREATE A QUESTIONNAIRE” button to start inputting information related to a new questionnaire. For example, the buyer might include a number of questions related to the size of the vendor, including past revenue last year, projected revenue this year, gross profit, net profit, number of employees working for vendor, etc. Vendors can choose to respond to the questionnaire or ignore it, as before.

FIG. 3 conceptually illustrates a continuation of the process 200 determining which, if any, of the possible actions have been received at 205. Specifically, the process 200 determines (at 280) whether the action was for creating an ROI tool. In some embodiments, the buyer may have a specific set of rules or parameters for determining a return on investment value. In some embodiments, the buyer can create an ROI tool for one or more vendors to use in response to the RFI. Thus, when the buyer has selected an action to create the ROI tool, the process 200 creates and shares (at 285) the ROI tool with one or more vendors specified by the buyer. In some embodiments, the buyer can create an ROI tool by one of creating a new ROI tool and selecting a saved ROI tool that was created previously. When the buyer creates a new ROI tool, in some embodiments the buyer will input one or more rules or parameters that constrain the ROI tool in a specific manner. For example, the buyer may include a rule to automatically perform a set of tax deductions for a capital expenditure. On the other hand, if an ROI was previously created and saved, in some embodiments the buyer can select the ROI tool from a list of previously saved ROI tools. In either case, the buyer can select one or more vendors with whom to share the ROI tool. Then the process transitions back to 205, as described above.

Additionally, if the buyer's action is determined (at 290) to be creation of a TCO tool, the process then creates and shares (at 295) the TCO tool with a specified list of members. As above for the ROI tool, the buyer can either select an existing, previously stored TCO tool to share with vendors, or can generate a new TCO tool based on a specific set of rules or parameters. After sharing the TCO tool, the process transitions back to 205 to receive the next action. If process 200 has not determined that any of the actions were called by the buyer, then the action is one of a logout action, an application closing action, or some other action that stops execution of the application that interfaces the buyer with the proxy environment. In this case, the process 200 ends.

While the process described by reference to FIGS. 2 and 3 is implemented by a buyer application 110, in some embodiments, a server software application (i.e., the RFI server application 120) performs a process that establishes a proxy environment based on a buying project of a particular buyer, thereby allowing anonymous research of one or more vendors who were invited to participate and accepted the invitation to participate in the buying project. As noted above, without the proxy environment described in this disclosure, it is exceedingly difficult for the buyer to get information from vendors without the buyer's identity being revealed. For instance, the buyer typically must visit vendor websites, social media sites which may reveal buyer profile properties or settings, send vendors email messages, or call the vendors directly on the phone. Each of these manners of interacting with vendors requires (expressly or inherently) the buyer to disclose their identity in order for the vendor to respond to the buyer's request for information. Thus, current systems are not able to hide buyer identity. However, unlike the current system, the RFI server software application acts as proxy for the buyer (making the buyer completely anonymous to the outside world) and invites only selected vendors to respond to buyer's requests for information (and thus, limiting leaks or guessing) without disclosing the buyer's identity.

II. Vendor Process for Participating in a Buying Project

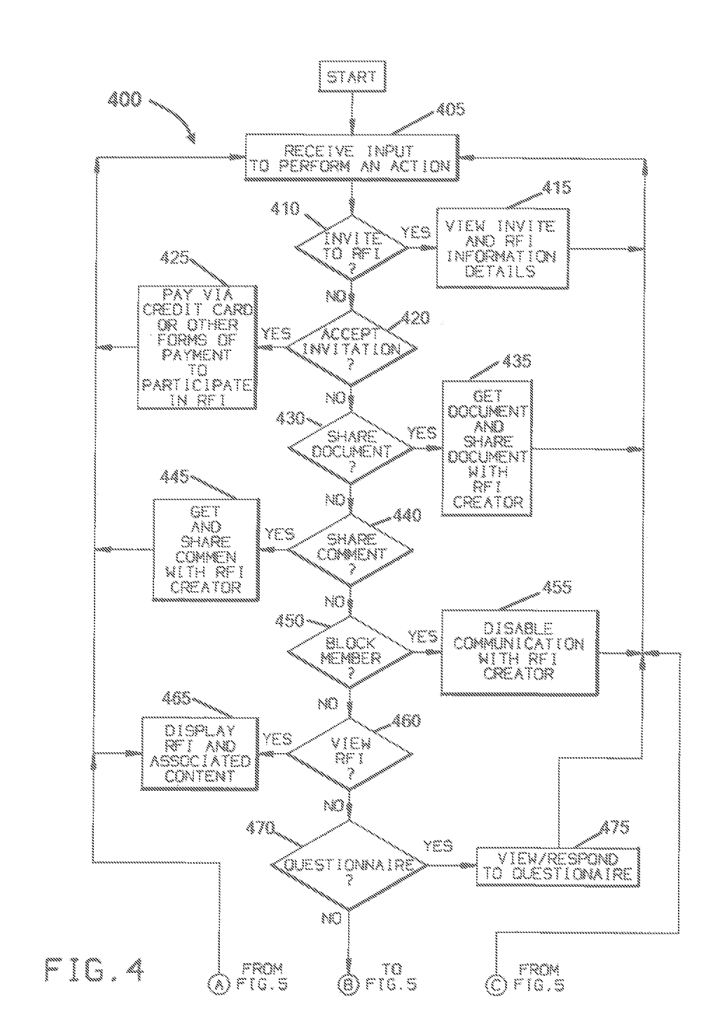

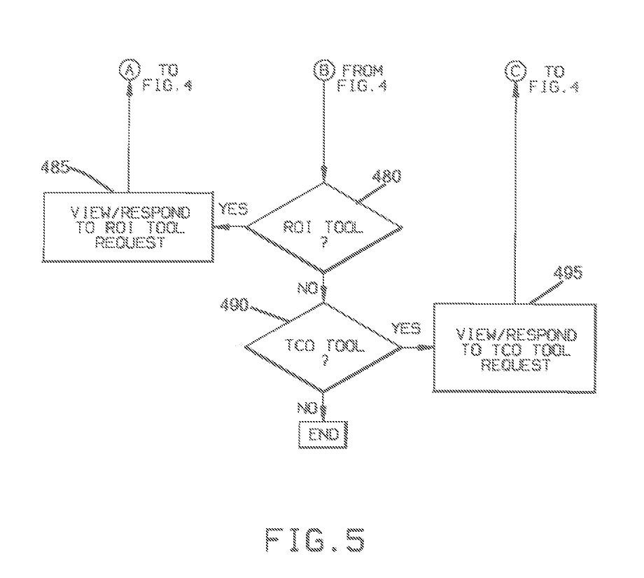

While the examples described by reference to the process 200 related to a buyer setting up a buying project and interfacing anonymously with one or more vendors participating in the buying project during a research and evaluation phase of the project, vendors who choose to participate in the buying project similarly have a number of ways to interact with the buyer in the proxy environment. Thus, from the vendor's standpoint, a similar process 400 is engaged in when the vendor is invited to participate in a buying project. FIGS. 4 and 5 conceptually illustrate, from the standpoint of a vendor, this process 400 for participating in the buying project and responding to queries for information. Also, vendors spend a lot of time and effort driving visitors to their websites. Since many visitors are not comfortable identifying themselves to the vendor on their website and would leave the website if their identity was required or revealed, many vendors prefer to provide an option to visitors of their website to communicate with them anonymously. This can be accomplished by using the proxy services described in this disclosure. Thus, a vendor merely needs to make a website tool or widget available for visitors to access from their website. Then, when a visitor with a buying project selects the tools or widget from the website, they will be directed back to the proxy site setup website to establish a new proxy environment related to their buying project. In this way, even buyers who are not familiar with the possibility of remaining anonymous while researching and evaluating vendors will be able to communicate with vendors anonymously.

As shown in FIG. 4, the process 400 starts with an RFI having already been created by a buyer. The buyer is anonymous to vendors through the proxy environment, which in some embodiments is implemented on the RFI server (e.g., via a web server operating as a set of services in a service oriented architecture, etc.). The vendor in some embodiments interfaces with the buyer through a vendor application (e.g., a web browser connected to a web application at the proxy server website). In some embodiments, the process 400 receives (at 405) an input to perform an action. Each vendor who connects to the proxy environment has a set of actions that can be selected and performed. In some embodiments, a limited set of actions are available for selection and operation before an expanded set of operations are available to the vendor for selection and operation. In particular, the vendor can only perform an action to view an invitation initially. Thus, the process 400 determines (at 410) if the vendor has viewed the invite. When the vendor views the invitation, the process proceeds to 415, in which the vendor views the RFI details. In some embodiments, the buyer has included several RFI details related to the buying project. For example, the buyer may have included (as shown by example in FIG. 6) the name of the RFI 602 and a summary description 603 of the RFI. In some embodiments, the vendor can view more information by clicking an option to expand the summary description into a more comprehensive description. After the vendor has viewed the invite and RFI details, the process 400 transitions back to 405.

At the next action after viewing the invitation, the process 400 determines (at 420) whether the vendor has accepted the invitation. In some embodiments, the vendor must affirmatively accept the invitation to participate in the buying project. In these embodiments, the vendor could simply ignore the invitation if they did not want to participate. However, if the vendor wishes to participate in the buying project, in some embodiments, the process receives payment (at 425) from vendor to participate in the buying project. In some embodiments, the vendor can pay via credit card or other established forms of payment, including debit card, check, etc. In other embodiments, however, no payment is required, so the process 400 simply skips the step at 425 and transitions back to 405 to receive the next action.

After the invitation has been viewed by the vendor and the vendor has affirmatively accepted the invitation to participate in the buying project associated with the RFI, in some embodiments the set of actions a vendor can select and perform is expanded. The set of actions include several actions that are similar and correspond to actions that a buyer can select and perform. In some embodiments, the set of actions comprise actions to retrieve buyer-posted documents and share documents with the buyer 435, actions to retrieve or view buyer comments and post comments for the buyer to view 445, an action to block communications with the buyer and buyer's colleagues 455 (e.g., the vendor no longer wishes to participate in the RFI, is tied up with other matters, or simply does not want to be disturbed by activities and events related to the RFI), an action to view the RFI 465 (and associated details), actions to view and respond to a questionnaire created by the buyer 475, an action to view and respond to an ROI tool request from the buyer 485, and an action to view and respond to a TCO tool request from the buyer 495 The process ends when the vendor has selected an action to close the proxy environment interfacing application or when the vendor has stopped execution of the process in some way.

Like the process 200, the steps in which process 400 determines which action has been input is shown in a particular linear order. Moreover, like the process 200, the order in which the process 400 determines which action has been input can be different from the order illustrated in FIGS. 4 and 5. In some embodiments, the process 400 necessarily must perform one or more of the determination steps prior to any other step. For instance, a vendor necessarily must view an invitation and accept the invitation to participate in the RFI before the process will determine whether the vendor has input any of the actions in the expanded set of actions. On the other hand, the process 400 in some embodiments starts when a vendor logs into the RFI after having previously viewed the RFI invitation and accepted the invite to participate in the RFI. In these cases, the process 400 starts by receiving an input (at 405) which could be any of the expanded set of actions. Thus, the ordering presented in this process 400 is merely presented as an example.

Furthermore, the orderings of steps in both of FIGS. 2-3 and FIGS. 4-5 presumes that the processes 200 and 400 perform their determinations linearly. However, in some embodiments, the processes 200 and 400 determine the input action in a non-linear fashion. Therefore, although the example processes 200 and 400 have specific orders for determining which action was input, in some other embodiments, the orders can be different, or non-linear determination processes are used (e.g., using a look-up table or index to reference an operation associated with an action, etc.).

III. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

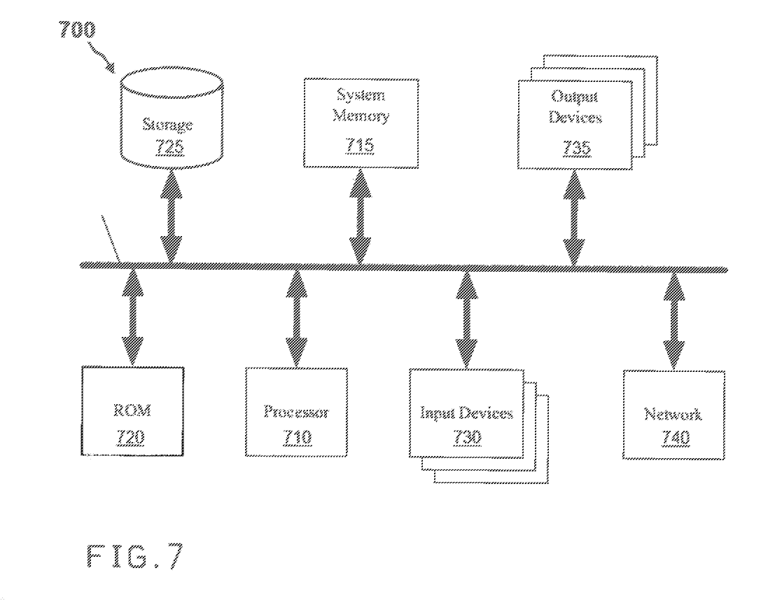

FIG. 7 conceptually illustrates an electronic system 700 with which some embodiments of the invention are implemented. The electronic system 700 may be a computer, phone, PDA, or any other sort of electronic device. Such an electronic system includes various types of computer readable media and interfaces for various other types of computer readable media. Electronic system 700 includes a bus 705, processing unit(s) 710, a system memory 715, a read-only 720, a permanent storage device 725, input devices X30, output devices X35, and a network X40.

The bus 705 collectively represents all system, peripheral, and chipset buses that communicatively connect the numerous internal devices of the electronic system 700. For instance, the bus 705 communicatively connects the processing unit(s) 710 with the read-only 720, the system memory 715, and the permanent storage device 725.

From these various memory units, the processing unit(s) 710 retrieves instructions to execute and data to process in order to execute the processes of the invention. The processing unit(s) may be a single processor or a multi-core processor in different embodiments.

The read-only-memory (ROM) 720 stores static data and instructions that are needed by the processing unit(s) 710 and other modules of the electronic system. The permanent storage device 725, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 725.

Other embodiments use a removable storage device (such as a floppy disk or a flash drive) as the permanent storage device 725. Like the permanent storage device 725, the system memory 715 is a read-and-write memory device. However, unlike storage device 725, the system memory 715 is a volatile read-and-write memory, such as a random access memory. The system memory 715 stores some of the instructions and data that the processor needs at runtime. In some embodiments, the invention's processes are stored in the system memory 715, the permanent storage device 725, and/or the read-only 720. For example, the various memory units include instructions for processing appearance alterations of displayable characters in accordance with some embodiments. From these various memory units, the processing unit(s) 710 retrieves instructions to execute and data to process in order to execute the processes of some embodiments.

The bus 705 also connects to the input and output devices 730 and 735. The input devices enable the user to communicate information and select commands to the electronic system. The input devices 730 include alphanumeric keyboards and pointing devices (also called “cursor control devices”). The output devices 735 display images generated by the electronic system 700. The output devices 735 include printers and display devices, such as cathode ray tubes (CRT) or liquid crystal displays (LCD). Some embodiments include devices such as a touchscreen that functions as both input and output devices.

Finally, as shown in FIG. 7, bus 705 also couples electronic system 700 to a network 740 through a network adapter (not shown). In this manner, the computer can be a part of a network of computers (such as a local area network (“LAN”), a wide area network (“WAN”), or an Intranet), or a network of networks (such as the Internet). Any or all components of electronic system 700 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, many of the figures illustrate example passwords with alphabet characters. However, a variety of other types of password tokens can be used in passwords, including numbers, punctuation marks, diacritical marks, symbols, and other such graphical elements. Thus, one of ordinary skill in the art would understand that the invention is not to be limited by the foregoing illustrative details and examples, but rather is to be defined by the appended claims. Additionally, the types of appearance changes are not limited in any way by the foregoing details and examples, but is instead are understood to include any type of appearance change that can be created from password tokens, in whole or in part as a person skilled in the art would understand.

Also, FIG. 1 illustrates an example schematic of a system for creating a virtual proxy environment associated with a buying project and which does not reveal buyer identifying information. The specific operational units associated with this schematic may not be organized in the system with exactly the same operational and functional relationships to other operational units. For instance, in order not to obscure the schematic shown in FIG. 1 with unnecessary detail, certain system functional and/or operational units have not been illustrated, including, for example, any communication and network management modules, administrative modules, database management systems, and a variety of other such functional units.

In addition, FIGS. 2-3 and 4-5 conceptually illustrate processes. The specific operations of these processes may not be performed in the exact order shown and described. Specific operations may not be performed in one continuous series of operations, and different specific operations may be performed in different embodiments. Furthermore, the processes could be implemented using several sub-processes, or as part of larger macro processes. Thus, one of ordinary skill in the art would understand that the invention is not to be limited by the foregoing illustrative details, but rather is to be defined by the appended claims.

We claim:

1. A non-transitory computer readable medium storing a program which when executed by at least one processing unit of a computing device creates a virtual proxy environment associated with a buying project of a buyer entity, said program comprising sets of instructions for:
receiving a set of information from a buyer for registering a buyer profile;
creating a buyer profile based on the set of information received for registering the buyer;
generating a proxy environment for facilitating interaction between the buyer and one or more vendors, wherein the set of information in the buyer profile is not disclosed to the vendors in the proxy environment;
receiving a set of vendor acceptances to a set of vendor invitations to participate in the buying project in the proxy environment, wherein each vendor acceptance associates the vendor with the proxy environment without revealing the set of information in the buyer profile;
generating a set of queries based on a set of informational requests of the buyer, said queries provided to the associated vendors in the proxy environment; and
receiving a set of vendor responses to the set of queries in the proxy environment, said vendor responses provided to the buyer for review in making a buying decision for the buying project.

2. The non-transitory computer readable medium of claim 1, wherein the set of information in the buyer profile comprises the buyer's identity.

3. The non-transitory computer readable medium of claim 1, wherein the program further comprises a set of instructions for sending invitations to vendors to participate in the buying project.

4. The non-transitory computer readable medium of claim 3, wherein the number of received vendor acceptances is less than the number of sent vendor invitations.

5. The non-transitory computer readable medium of claim 1, wherein the program further comprises a set of instructions for receiving a document uploaded by the buyer, wherein at least one query in the set of queries comprises a request for a particular vendor to review and respond to a buyer document uploaded into the proxy environment by the buyer.

6. The non-transitory computer readable medium of claim 5, wherein the program further comprises a set of instructions for receiving a document uploaded by a vendor, wherein a vendor document is uploaded into the proxy environment by the particular vendor in response to the request to review and respond to the buyer document.

7. The non-transitory computer readable medium of claim 1, wherein at least one query in the set of queries comprises a questionnaire for a set of vendors to review.

8. The non-transitory computer readable medium of claim 1, wherein the program further comprises a set of instructions for receiving a comment to post in the proxy environment.

9. The non-transitory computer readable medium of claim 8, wherein the comment is a comment of the buyer for only a particular vendor to view.

10. The non-transitory computer readable medium of claim 8, wherein the comment is a comment of the buyer for all vendors participating in the buying project to view.

11. The non-transitory computer readable medium of claim 8, wherein the comment is a comment of a particular vendor for only the buyer to view.

12. The non-transitory computer readable medium of claim 1, wherein the program further comprises a set of instructions for receiving a request to create the proxy environment before said receiving the set of information from the buyer.

13. The non-transitory computer readable medium of claim 12, wherein the request to create the proxy environment is received from a vendor website after a tool displayed on a graphical user interface of the vendor website is selected.

14. The non-transitory computer readable medium of claim 12, wherein the request to create the proxy environment is received from a partner website after a tool displayed on a graphical user interface of the partner website is selected, wherein the partner website is associated with a partner of a vendor.

15. The non-transitory computer readable medium of claim 12, wherein the request to create the proxy environment is received from an affiliate website after a tool displayed on a graphical user interface of the affiliate website is selected.

16. A system for a buyer to interact with a set of vendors with respect to a particular buying project, wherein the system hides identity of the buyer so that the buyer interacts anonymously with the vendors, said system comprising:
a buyer computing device comprising a processor on which a buyer application operates for the buyer to (i) request that a proxy environment be established to anonymize the buyer's identity in association with the buying project, (ii) request the set of vendors to be invited to participate in the buying project, and (iii) interact with vendors anonymously;
a server computing device comprising a processor on which an RFI server application operates to (i) receive a request from the buyer to establish the proxy environment, (ii) set up the proxy environment, (iii) configure the proxy environment to anonymize the buyer's identity, (iv) send invitations to the set of vendors to participate in the buying project, and (v) manage communications between the buyer and vendors in the proxy environment; and
a set of vendor computing devices, each vendor computing device comprising a processor on which a vendor application operates for the vendor to (i) accept the invitation to participate in the buying project and (ii) interact with the buyer, said interaction always maintaining anonymity of the buyer.

17. The system of claim 16, wherein the buyer application comprises a plurality of buyer tools for interacting with vendors in the proxy environment associated with the buying project.

18. The system of claim 17, wherein the vendor application comprises a plurality of vendor tools for interacting with the buyer in the proxy environment associated with the buying project, each vendor tool for interacting with the buyer maintaining the anonymity of the buyer.

19. The system of claim 18, wherein the RFI server application comprises a plurality of RFI modules for managing communications between the buyer and vendors in the proxy environment associated with the buying project.

20. The system of claim 19, wherein each module in the plurality of RFI modules corresponds to at least one of a buyer tool in the plurality of buyer tools and a vendor tool in the plurality of vendor tools.
